(19) United States
(12) Patent Application Publication
(10) Pub. No.: US 2009/0033668 A1
(43) Pub. Date: Feb. 5, 2009

(54) Display EDID emulator system and method

(76) Inventors: Douglas A. Pederson, Corvallis, OR (US); Matthew David Smith, Corvallis, OR (US); Brian J. Gudge, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,292

(22) Filed: Jul. 31, 2007

(51) Int. Cl. G06F 13/14

(52) U.S. Cl. 345/520

(57) ABSTRACT

Various embodiments of a display EDID emulator system and method are disclosed.

### BACKGROUND

This disclosure relates generally to the transmission of EDID (Extended Display Identification Data) within an audio-visual (AV) system. In AV systems, sink devices (devices receiving video or audio data, such as a display) frequently use an EDID to expose information about the sink device's capabilities to the device sending or generating the audio and video input (the generator or source). The EDID is a block of data (e.g. 128 bytes) describing capabilities of the sink device. Typically the generator reads the sink device's EDID, and then uses this information to determine the optimal format to use when sending data to the sink device.

However, it is often desired to have some form of video processing between a video/graphics generator and a display. Many video generators, such as personal computers, require a valid EDID before they will provide video in the correct format, or at all. If it is desired to have a video/graphics source such as a PC hooked up to external video processing hardware, a valid EDID must be provided. Some video processing units provide an EDID specific to that unit. This often does not provide a solution that the display will work with. Video processing equipment, such as a video processor that is interposed between the video source and sink, can block the display's EDID from the generator. This can cause the generator to provide no video or the wrong format of video. Additionally, video processing equipment or other devices that are associated with a computer or communications network can also block a display device's EDID from reaching a source device at a remote location.

### BRIEF DESCRIPTION OF THE DRAWINGS

Various features and advantages of the present disclosure will be apparent from the detailed description which follows, taken in conjunction with the accompanying drawings, which together illustrate, by way of example, features of the present disclosure, and wherein:

FIG. 1 is a schematic diagram of a typical connection of a video source and sink;

FIG. 2 is a schematic diagram of a video source and sink interconnected with a video processor or analyzer device interposed between the two and incorporating one embodiment of a display EDID emulation system in accordance with the present disclosure;

FIG. 3 is a schematic diagram of a video source and sink with two intermediate video processor or analyzer devices and being configured for display EDID emulation in accordance with the present disclosure;

FIG. 4 is a flow chart of the process flow for one embodiment of a local EDID emulation system in accordance with the present disclosure;

FIG. 5 is a schematic diagram of one embodiment of the hardware for a local EDID emulation system in accordance with the present disclosure;

FIG. 6 is a flow chart of the process flow for one embodiment of an EDID emulation system configured to operate over a network in accordance with the present disclosure; and

FIG. 7 is a schematic diagram of one embodiment of the hardware for an EDID emulation system configured to operate over a network in accordance with the present disclosure.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure.

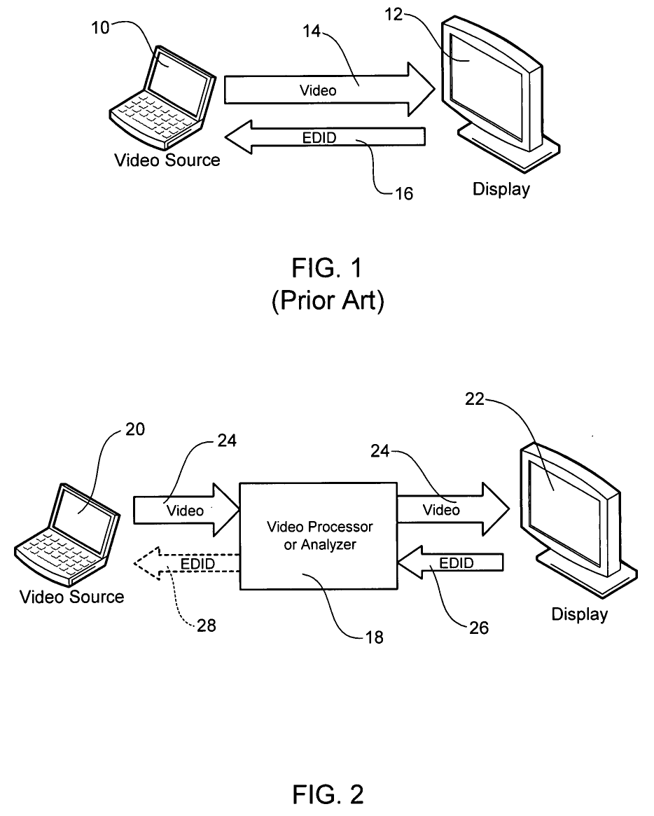

As noted above, this disclosure relates generally to the transmission of Extended Display Identification Data (EDID) within an audio-visual (AV) system. In AV systems, sink devices (devices receiving video or audio data, such as a video display) frequently use an EDID to expose information about the sink device's capabilities to the source device (the device that is sending or generating the audio and video input, such as a computer device). The EDID is a block of data (e.g. 128 bytes) describing capabilities of the sink device. Typically the source reads the sink device's EDID, and then uses this information to determine the optimal format to use when sending data to the sink device. A typical arrangement is shown in FIG. 1. In this arrangement a source device 10 (e.g. a laptop computer as shown) is connected directly to a sink device 12 (e.g. a display as shown). Video data is transmitted to the sink device, as represented by arrow 14, while EDID data is transmitted to the source device, as represented by arrow 16. This allows the video source device to directly read the display's EDID.

However, it is often desired to have some form of video processing between a video/graphics generator and a display. For example, a video processor can be used for scaling the video (e.g. adjusting the resolution), filtering (e.g. detail enhancement, noise reduction, etc.), color enhancement, gamma correction, frame rate conversion, ceinterlacing, and doing graphics overlays (e.g. picture-in-picture, picture-on-picture, user interfaces, etc.). This type of arrangement is shown in FIG. 2, in which a video processor 18 is interposed between a video source device 20 and a display 22. In this configuration, video data, represented by arrows 24, is transmitted from the source to the video processor device, and then from the video processor to the display. Similarly, the EDID information is transmitted from the display to the video processor, as represented by arrow 26. It is desired that the EDID be subsequently transmitted to the video source, as represented by arrow 28. However, some video processing equipment, such as the video processor 18, can block the display's EDID from reaching the source. Arrow 28 is shown in dashed lines to represent this possibility. Additionally, some video processing units provide an EDID that is specific to the video processing unit. This often does not provide a solution that the display will work with. Since many video sources, such as personal computers and laptops, require a valid EDID before they will provide video in the correct format, or at all, this can cause the source to provide no video or the wrong format of video.

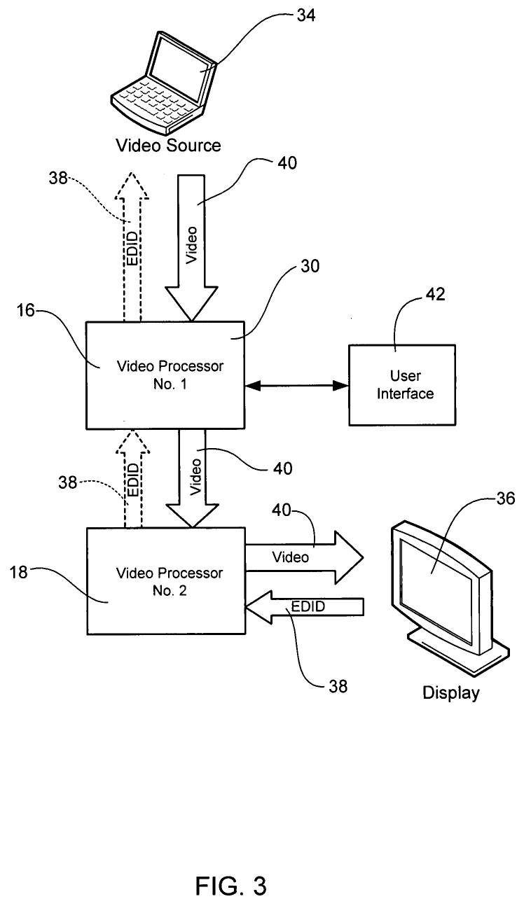

A similar situation is shown in FIG. 3, wherein a first video processor 30 and second video processor 32 are interposed between the source 34 and display 36. In this configuration, it is possible that either of the video processors can prevent transmission of the EDID information, represented by arrows 38, thus harming the video format, or entirely preventing transmission of video, represented by arrows 40.

Advantageously, the inventors have developed a display EDID emulator system and method for a video processor, which can operate in the situations shown in FIGS. 2 and 3 and other situations, to enable video processing equipment to be inserted between a video/graphics generator and a display without preventing proper transmission of EDID information. This enables the generator to transmit the correct video format, allowing the generator to match the display's requirements to best of its ability.

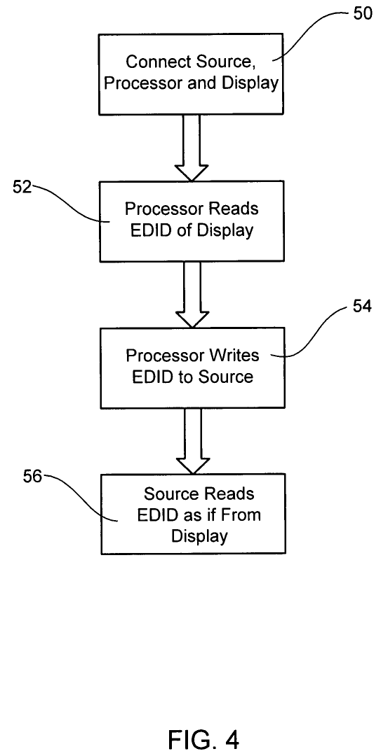

The steps in one embodiment of this method are outlined in FIG. 4. The video processing equipment is first connected between a video/graphic source and a display (step 50). This can involve connecting an RGB (e.g. 15 pin Dsub), HDMI or DVI cable from the source to the processor and from the processor to the display. After connection of the source and display to the processor, the processor reads the entire EDID from the display (step 52). This can involve hardware of the video processor connecting to the I2C/DDC lines on the RGB/HDMI/DVI cable, and initiating an I2C/DDC read from the EDID (e.g. stored in a memory device such as electronically erasable programmable read-only memory (EEPROM)) in the display.

The pertinent information from the display's EDID is then written to or presented to the source (step 54), being presented as the processor's EDID, thus emulating the display. In this step hardware of the video processor can write the data that was read from the display's EDID to the appropriate video input port where the video source's RGB or DVI cable is connected. Consequently, any future EDID reads by the source over the RGB, HDMI or DVI cable will be read by the video source as if the processor were the display. This produces the situation illustrated in FIG. 2, wherein the EDID information 26 that is read by the processor 18 is passed on to the source 20, as indicated by arrow 28. The source or signal-generating device thus receives an emulated EDID that makes it “think” that it is communicating directly with the display. This allows the video source to continuously match the requirements of the display to the best of its ability.

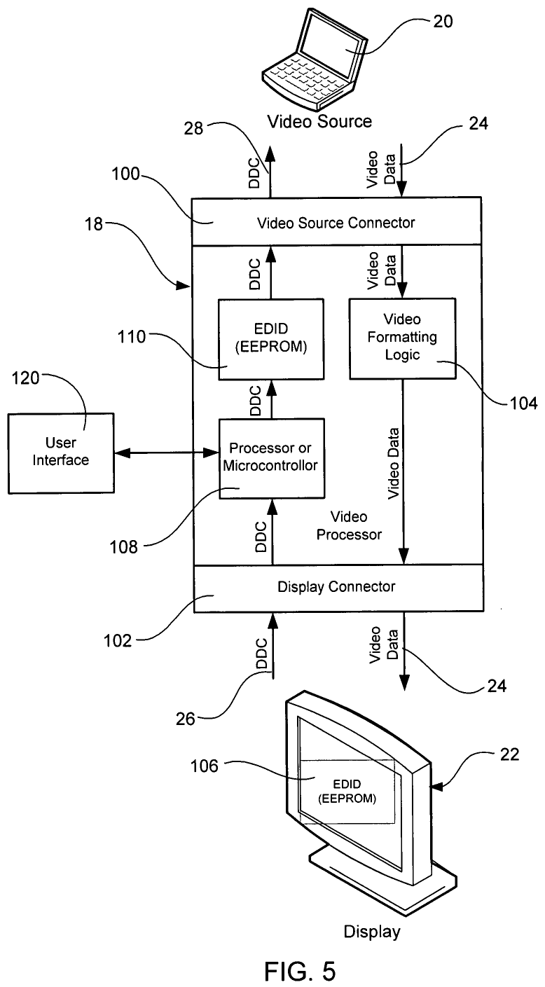

A more detailed schematic diagram of the hardware involved in the configuration shown in FIG. 2 and which can accomplish the method outlined in FIG. 4 is shown in FIG. 5. The video processor device 18 includes one or more video source connectors 100 (e.g. RGB, DVI or HDMI), which are connected to the video source 20, and one or more display connectors 102 (e.g. RGB, DVI, HDMI), which are connected to the display 22. The video data that is provided by the source (represented by arrow 24) is received by a video formatting logic module 104 of the video processor, and is then passed onto the display through the display connector 102.

The EDID information of the display 22 can be stored in an EEPROM device 106 in the display. This information is provided through the display connectors 102 to the processor 18 via the DDC line 26, after which it is processed by a microprocessor or microcontroller 108. The processor can then store the display's EDID information in an EEPROM device 110 in the processor, and then pass this information on to the source via DDC line 28. Each time the source requires EDID information it can access this information in the processor, and receive the same EDID information as if it were connected directly to the display.

Another embodiment of the method is used in the hardware situation shown in FIG. 3, where two video processors are directly connected together. This method involves using the second video processor 32 to read the EDID information from the display 36, and then transfer this information to the first video processor 30 and save it as that video processor's input video EDID, so that upon seeking EDID information the video source 34 will “think” that it is talking directly to the display.

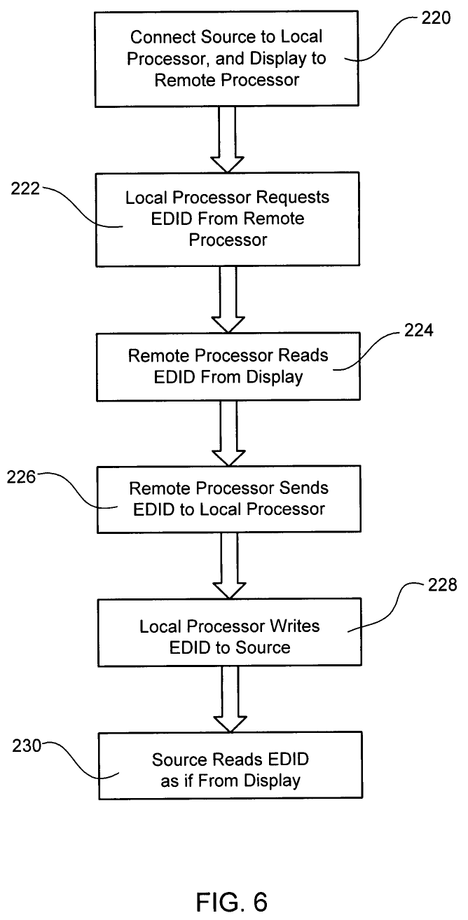

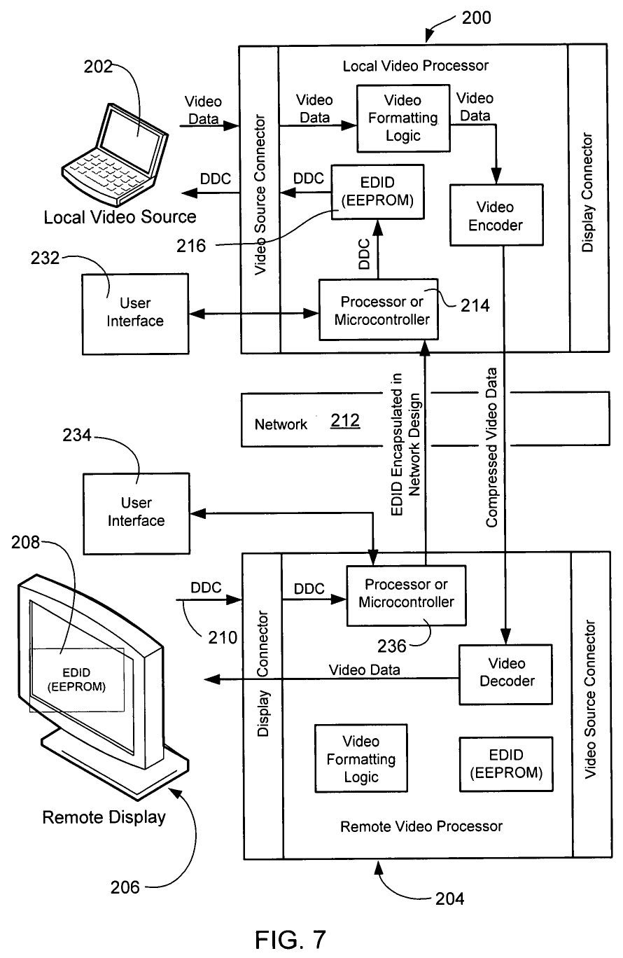

Still another embodiment of an EDID emulation system and method is outlined in FIGS. 6 and 7, and relates to systems in which two video processor units are interconnected via a network. Referring to the steps shown in FIG. 6 and the hardware shown in FIG. 7, a first local video processor 200 is interconnected to a local video source 202 (step 220 in FIG. 6). A second remote video processor 204 is interconnected to a display 206 that is in a location remote from the video source (step 220 in FIG. 6). The local and remote video processors can be configured like the video processor 18 of FIG. 5, and a complete description of the same components will not be repeated here. The local processor 200 then requests EDID information from the remote processor 204 (step 222) over a network 212 (e.g. a Local Area Network (LAN), the Internet, etc.) that interconnects the two video processors. The remote display 206 includes memory, such as EEPROM 208 that stores the EDID information for that display. The remote video processor reads the entire EDID from the display (step 224) via the DDC line 210. This EDID information is then sent over the network 212 to the local video processor 200 (step 226).

The local processor 200 includes a processor or microcontroller 214 that reads the EDID information and stores it in memory, such as EEPROM 216, and also writes the EDID to the source 202 (step 228). Consequently, the video source 202 will read an emulated EDID that matches the EDID of the remote display 208, as if the source were directly connected to the display (step 230).

The hardware associated with the embodiments outlined in FIGS. 6 and 7 can be physically arranged in many different ways. For example, the local video processor 200 can be physically located in the same room as the video source 202, or it can be separated some distance. Likewise, the remote display 206 and the remote video processor 204 can be located in the same room, or they can be separated. It is to be understood that the network 212 is not limited to one physical network, but can comprise multiple networks that are interconnected. For example, the local and remote video processors can each be interconnected to a local network, with each local network in turn being connected to the Internet (or some other intermediate network) to create the desired connection. Any network or combination of networks that allows the desired communication between the local and remote video processors can be used.

This configuration of local and remote processors, as described with respect to FIGS. 6 and 7, can be useful for remote video conference systems, for example, where the video source is a camera, associated with a first video conference room, and the display is associated with a second video conference room and displays the images taken by the camera. An inverse system can also be provided with a camera in the second video conference room that acts as a source for a display in the first video conference room. This allows participants in each room to see and hear each other in real time. It is to be appreciated that the first and second video conference rooms can be relatively near to each other or very far away.

Additional embodiments of the display EDID emulation system and method described herein can be configured to allow user control or input of EDID information. For example, as shown in FIG. 3, a user interface 42 can be associated with the first video processor 30. The user interface can include a data entry device (e.g. a keyboard, not shown) and a feedback device (e.g. a display screen, not shown) to assist the user in entering data. As shown in FIG. 5, a user interface 120 can be functionally connected to the processor or microcontroller 108 of an associated video processor 18, allowing direct input of data that affects the operation of the video processor. This configuration allows a user to manually create an EDID and store it in the video processor, or to edit or manipulate EDID information that resides in the video processor. This new EDID can then be presented to the video source (34 in FIG. 3, 20 in FIG. 5) so that the video source will output video according to this new EDID. This can be useful for adjusting an EDID or for video testing.

It will be apparent that user interfaces can be associated with an EDID emulation system and method as described herein in a variety of different ways. For example, while the user interface 42 shown in FIG. 3 is associated with the first video processor 30, it could just as easily be associated with the second video processor 32, or each video processor could have its own user interface. Other alternative embodiments are shown in FIG. 7. For example, a user interface 232 can be interconnected to the microcontroller 214 of the local video processor 200 in the manner discussed above. Though not shown, a user interface could also be associated with the remote video processor 204. Alternatively, a user interface 234 can be associated with the microcontroller 236 of the remote video processor 204. It will be apparent that other configurations for user interfaces are also possible to allow a user to directly input or manipulate EDID information. As yet another alternative, in many cases the video can function as a user interface. For example, viewing FIG. 3, the source 34 can function as a user interface for its associated video processor 30. Where the source is a computer device (e.g. a PC or laptop computer) it will already include the data entry devices needed to allow a user to provide input to the video processor. This same concept can apply to other embodiments described herein.

Advantageously, the various EDID emulation system embodiments described above allow EDID information to be accumulated and stored in the video processors. All previous EDIDs (including those that have been directly passed on, as in the embodiments of FIGS. 2 and 5, those that have been transmitted over a network, as in the embodiments of FIGS. 3 and 7, and those that were manually created/edited via a user interface) could be stored in the video processing hardware (e.g. the EEPROM 216 in FIG. 7) and then be selected to be presented as the processor's EDID to the video source. This way the video processing hardware does not have to currently be connected to an EDID (directly or over the network) in order to present that EDID to the video source. This can allow for greater flexibility in hardware configurations.

This display EDID emulator system and method disclosed herein enables video processing equipment to be inserted between a video/graphics generator and a display while still enabling the generator to transmit the correct video format. In one embodiment the video processing equipment is connected between a video/graphic source and a display, and reads the entire EDID from the display. The pertinent information from the display's EDID is then presented as the processor's EDID, thus emulating the display. In other embodiments the system and method allows a signal generating device in one location to be provided with an emulated EDID over a network to make it “think” that it is communicating directly with a display that is located at a remote location, when in fact it is communicating with other hardware that is interposed between the generator and the display. This allows the video source to match the requirements of the display to the best of its ability.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims.

What is claimed is:

1. A method for display EDID emulation, comprising the steps of:
interconnecting a first video processor between a video source and display;
reading an EDID of the display via the first video processor;
creating and storing an emulated EDID in the first video processor based upon the display EDID; and
writing the emulated EDID from the first video processor to the video source, whereby the video source receives the emulated EDID as if read from the display.

2. A method in accordance with claim 1, further comprising the step of causing the source to subsequently read the emulated EDID from the first video processor as if read from the display.

3. A method in accordance with claim 1, further comprising the step of modifying a video signal between the source and the display via the first video processor by a step selected from the group consisting of scaling, filtering, color enhancement, gamma correction, frame rate conversion, deinterlacing, and performing graphics overlays.

4. A method in accordance with claim 1, wherein the step of interconnecting the first video processor between the video source and the display comprises:
interconnecting the first video processor to an electronic communications network; and
interconnecting the source to the communications network, whereby the video processor communicates with the source via the network.

5. A method in accordance with claim 4, further comprising the step of providing user-generated EDID information to the first video processor via a user interface interconnected to the first video processor.

6. A method in accordance with claim 1, wherein the step of writing the emulated EDID from the first video processor to the video source further comprises the steps of:
writing the emulated EDID from the first video processor to a second video processor;
storing the emulated EDID in memory in the second video processor; and
writing the emulated EDID from the second video processor to the source, whereby the source receives the EDID as if read from the display.

7. A method in accordance with claim 6, wherein the step of writing the emulated EDID from the first video processor to the second video processor comprises writing the emulated EDID from the first video processor to the second video processor at a remote location via an electronic communications network.

8. A method in accordance with claim 6, further comprising the step of causing the source to subsequently read the emulated EDID from the second video processor as if read from the display.

9. A method in accordance with claim 1, further comprising the step of entering user-generated EDID information in at least one of the first and second video processors via a user interface interconnected to at least one of the first and second video processors.

10. An EDID emulation system, comprising:
a video source, located at a first location;
a video display, located at a second location remote from the first location; and
a first video processor, interconnected between the source and the display, configured to read an EDID of the display, and to emulate the EDID and provide the emulated EDID to the source.

11. A system in accordance with claim 10, further comprising an electronic communication network, interconnecting the source and the first video processor, whereby the first video processor communicates with the source via the network.

12. A system in accordance with claim 11, wherein the electronic communication network is selected from the group consisting of a local area network, and the Internet.

13. A system in accordance with claim 10, further comprising a user interface, associated the first video processor, configured to allow user input of EDID information to the first video processor.

14. A system in accordance with claim 10, further comprising a second video processor, interconnected to the first video processor, configured to read the emulated EDID from the first video processor, and to provide the emulated EDID to the source.

15. A system in accordance with claim 14, further comprising a user interface, associated with at least one of the first and second video processors, configured to allow user input of EDID information to the associated video processor.

16. A program product, comprising machine readable program code for causing a first video processing device to perform the steps of:
reading an EDID of a video display;
creating and storing an emulated EDID based upon the display EDID; and
writing the emulated EDID to a video source via an electronic communications network, whereby the video source receives the emulated EDID as if read from the display.

17. A program product in accordance with claim 16, further comprising program code for causing the source to subsequently read the emulated EDID from the first video processor as if read from the display.

18. A program product in accordance with claim 16, further comprising program code for receiving user input via a user interface interconnected to the first video processing device.

19. A program product in accordance with claim 16, further comprising program code for writing the emulated EDID from the first video processing device to a second video processing device via the electronic communications network, and for writing the emulated EDID from the second video processing device to the source.

20. A program product in accordance with claim 19, further comprising program code for receiving user input via a user interface interconnected to at least one of the first and second video processing devices.
